(19) United States
(12) Patent Application Publication
(10) Pub. No.: US 2012/0049751 A1
(43) Pub. Date: Mar. 1, 2012

(54) TRANSFORMER-FREE LED LIGHTING DEVICE DIRECTLY UTILIZING THE AC POWER FROM CITY ELECTRICITY

(76) Inventor: Zhikang WANG, Kowloon (CN)

(21) Appl. No.: 13/027,034

(22) Filed: Feb. 14, 2011

(30) Foreign Application Priority Data
Aug. 26, 2010 (CN) 201010226043.3

(51) Int. Cl. H05B 37/02

(52) U.S. Cl. 315/187

(57) ABSTRACT

The present invention relates to a transformer-free LED lighting device using the AC power from city electricity directly, which comprises a coupling capacitor, a bridge rectifier circuit and a current limiting resistor, wherein, there is a current limiting resistor cascading between the first input end of the bridge rectifier circuit and the first leading-in end of the electrical source of the AC power from city electricity, there is a coupling capacitor cascading between the second input end of the bridge rectifier circuit and the second leading-in end of the electrical source of the AC power from city electricity, there is a LED tube connecting between two output ends of the bridge rectifier circuit. The transformer-free LED lighting device using the AC power from city electricity directly. This invention shall simplify the circuit structure and reduce production cost for LED lighting devices. It is catered for the mass-production.

### TECHNICAL FIELD

This invention allows the Transformer-Free LED lighting device, to be directly powered by the AC power from city electricity.

### BACKGROUND ART

The use of LED plays an increasingly important role with more and more attention to global energy problems since the light-emitting diode (LED) represents luminous source with higher luminous efficiency and less heavy metal pollution. Due to the characteristic of LED, it requires the low-voltage DC power source, Therefore a relatively complex transformer converting high-voltage AC to low-voltage DC is needed when the LED is powered by AC power from city electricity. This causes a lot of disadvantages such as production difficulties, increase of costs and reduction of reliability, etc.

### DISCLOSURE OF INVENTION

To solve the above problems, this invention provides a transformer-free LED lighting device using the AC power from city electricity directly, the LED lighting uses the capacitor charge-discharge technology and the bridge rectifier coupling. The light-emitting diode (LED) can then use the AC power from city electricity directly. At the same time, the LED lighting life may be extended and the cost of LED products may be reduced.

The transformer-free LED lighting device using the AC directly from city electricity in this invention that comprises a coupling capacitor, a bridge rectifier circuit and a current limiting resistor, wherein, there is a current limiting resistor cascading between the first input end of the bridge rectifier circuit and the first leading-in end of the electrical source of the AC power from city electricity, there is a coupling capacitor cascading between the second input end of the bridge rectifier circuit and the second leading-in end of the electrical source of the AC power from city electricity, there is a LED tube connecting between two output ends of the bridge rectifier circuit.

The coupling capacitor is used to limit the current used by the device and exempts the circuit from the requirement of the transformer.

The LED tube may contain one or more, LED chips in series which connects between two output ends of the bridge rectifier circuit.

The current limiting resistor is used to protect the device in the case of sudden changes of AC conditions.

The bridge rectifier circuit makes the LED tube emitting light during every “charge and discharge” cycle of capacitor, so LED tube fulgurates twice every AC cycle to avoid the visible glitter.

The bridge rectifier circuit ensures that the same LED tube provides the same brightness during the “charge and discharge” cycle to eliminate the twinkling effect that happens when utilizing separate LED tubes for of the different group while charge and discharge cycles.

This invention has the following advantages:

1. Saving energy

This invention does not require transformer while applying the light-emitting diode LED technology, so that LED can be more extensively applied to the general lighting consequently save more electrical energy.

2. Easy to apply

1) By using this invention, the circuit for converting AC high-voltage to DC low-voltage is avoided and it is more suitable for mass production.

2) The coupling capacitor is mainly made of ceramic material. This coupling capacitors, together with resistors and LED are all highly reliable electronic components and commonly used. By utilizing this type of components, the product physical size is significantly smaller and the cost is reduced consequently, it is more convenient to apply this invention to the LED technology used in lighting applications and requirements.

3) After using capacitors and resistors, the device can be made suitable for a wider application range, the device is suitable for the larger fluctuation in the AC power source from city electricity. The product reliability is improved simultaneously.

3. Protecting the environment

This invention doesn't contain any hazardous materials so that, it is more environmentally friendly than the current large-scale use of energy-saving lamps—CCFL. For utilizing all electronic components design, the product life is extended and the waste is reduced, hence it is beneficial to the protection of the environment.

### DESCRIPTION OF THE DRAWINGS

FIG. 1 is the schematic diagram of this invention. that is the transformer-free LED lighting device directly utilizing the AC power from city electricity.

FIG. 2 is the relationship diagram of input voltage and time in the transformer-free LED lighting device directly utilizing the AC power from city electricity in Example 2.

FIG. 3 is the relationship diagram of change of voltage on both sides of the capacitor with time in the transformer-free LED lighting device directly utilizing the AC power from city electricity in Example 2.

FIG. 4 is the relationship diagram of the change of voltage on both sides of the LED with time in the transformer-free LED lighting device directly utilizing the AC power from city electricity in Example 2.

FIG. 5 is the relationship diagram of the change of current flowing through the capacitor with time in the transformer-free LED lighting device directly utilizing the AC power from city electricity in Example 2.

FIG. 6 is the relationship diagram of the change of current flowing through the LED with time in the transformer-free LED lighting device directly utilizing the AC power from city electricity in Example 2.

FIG. 7 is the relationship diagram of input voltage and time in the transformer-free LED lighting device directly utilizing the AC power from city electricity in Example 3.

FIG. 8 is the relationship diagram of the change of voltage on both sides of the capacitor with time in the transformer-free LED lighting device directly utilizing the AC power from city electricity in Example 3.

FIG. 9 is the relationship diagram of the change of voltage on both sides of the LED with time in the transformer-free LED lighting device directly utilizing the AC power from city electricity in Example 3.

FIG. 10 is the relationship diagram of current the change of flowing through the capacitor with time in the transformer-free LED lighting device directly utilizing the AC power from city electricity in Example 3.

FIG. 11 is the relationship diagram of the change of current flowing through the LED with time in the transformer-free LED lighting device directly utilizing the AC power from city electricity in Example 3.

### MODE OF THE INVENTION

Thereafter this invention will be described in details to make clear of the above-mentioned features and advantages for the invention.

### EXAMPLE 1

The transformer-free LED lighting device directly utilizing the AC power from city electricity is shown in FIG. 1. The transformer-free LED lighting device directly utilizing the AC power from city electricity comprises the bridge rectifier circuit (Diode Bridge), there is a current limiting resistor R cascading between the first input end of the bridge rectifier circuit and the first leading-in end of the electrical source of the AC power from city electricity, there is a coupling capacitor C cascading between the second input end of the bridge rectifier circuit and the second leading-in end of the electrical source of the AC power from city electricity, there is a LED tube connecting in series and/or parallel connection between two output ends of the bridge rectifier circuit.

In this invention, The circuit was constituted using the capacitor C and resistor R, going through the bridge rectifier and driving a series of the light-emitting diode LED after electrifying. The capacitor C can control the quantity of electricity of the AC and save a certain amount of electricity every charge and discharge, thus the light-emitting diode (LED) is driven to emit light, the process is called coupling. The current size may be determined by the capacitor C according to the demand. And since the current limiting resistor R can limit the peak value of the current, the current size may be defined according to the demand, the whole circuit can be protected when the city electricity is not stable. The bridge rectifier can convert AC to DC; simultaneously the frequency of AC is doubled from 50 or 60 hertz (Hz) to 100 or 120 hertz (Hz), and people's eyes can not detect the twinkling at this frequency. The through current coupled by the capacitor C, limited by the resistor R and converted by the bridge rectifier (Diode Bridge) will drive a series of the light-emitting diode (LED) to emit light, thus the illumination light is produced. And different number of light-emitting diode LED may be added according to different demand of the illumination brightness. Multiple sets of emitting-light circuit may be placed in parallel to emit light if the higher brightness is needed.

### EXAMPLE 2

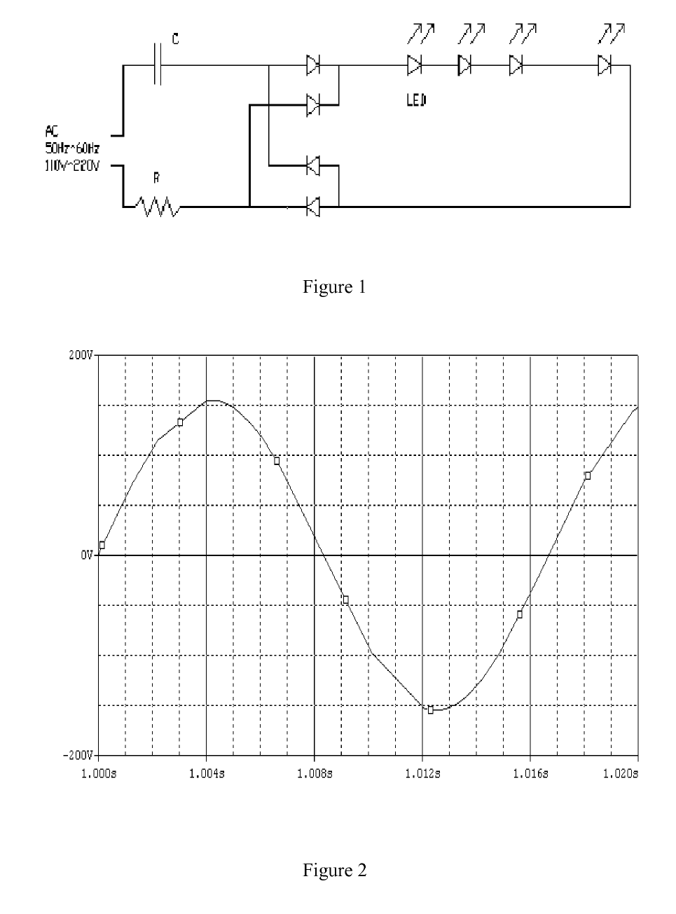

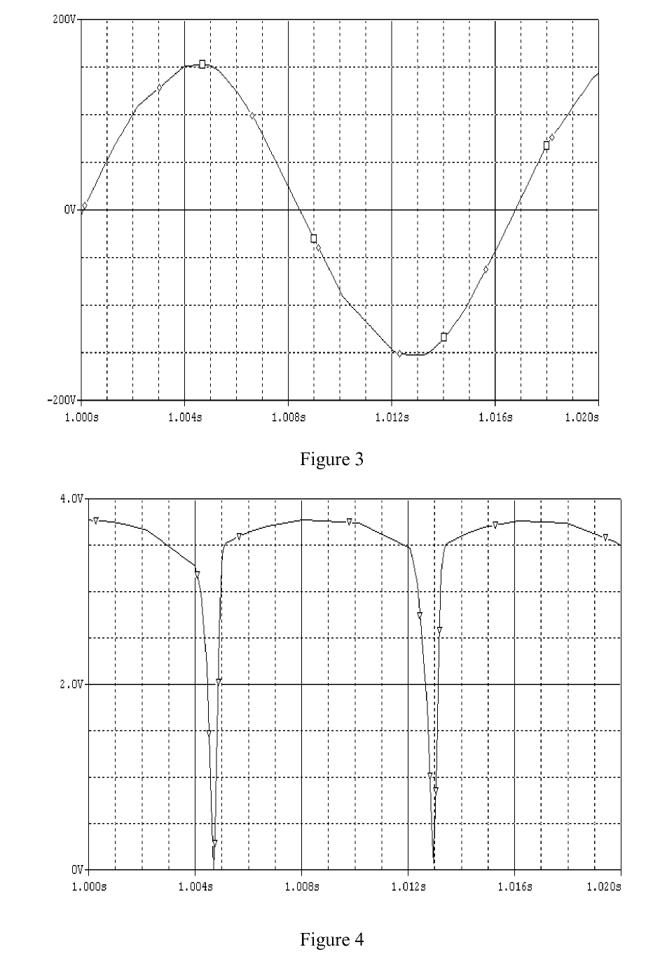

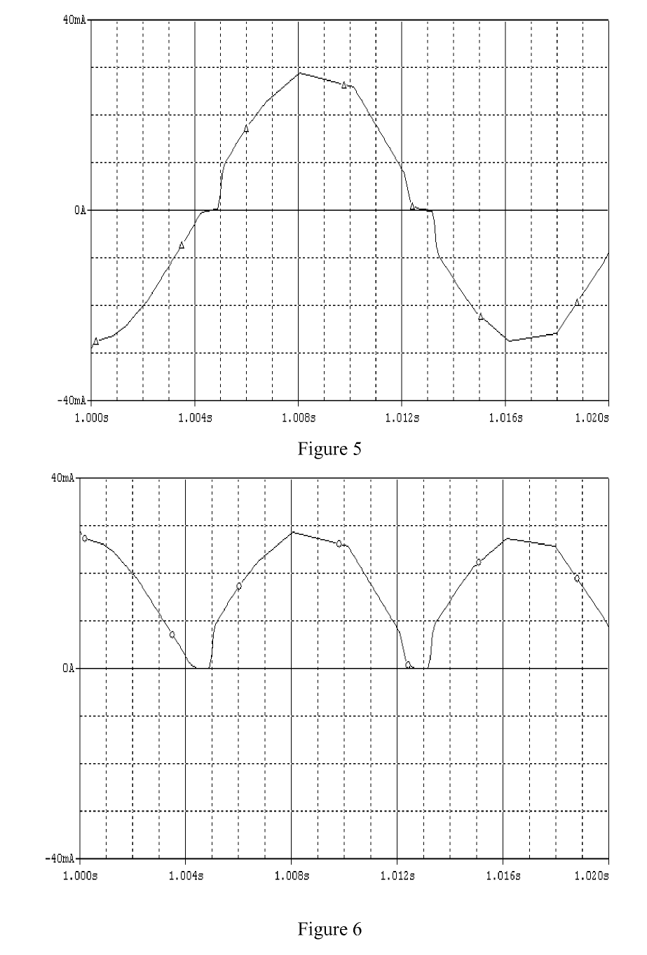

The transformer-free LED lighting device directly utilizing the AC power from city electricity in example 1 is used, wherein the AC is 110V, and there is one LED connecting between two output ends of the bridge rectifier circuit. The relationship among input voltage and time, the change of the voltage on both sides of the capacitor, the voltage of both sides of the LED, the current flowing through the capacitor and the current flowing through the LED with time are analyzed respectively, the results are shown in the FIGS. 2 to 6, the capacitance is adjusted to 0.47 u, and it may cause the LED current to be 20 mA and the voltage on both sides of the LED to be 3.5V, the AC is flowing through the capacitor, the current is 20 mA, the DC is flowing through the LED, the current is 20 mA. When going through the rectifier bridge, the current is changed from AC to DC, and the frequency is doubled. The actual power consumption of the whole current is about 3.5V×20 mA=70 mW, the actual power consumption of AC is 110V×20 mA=2200 mW, so the power factor is 70/2200=3.01%.

### EXAMPLE 3

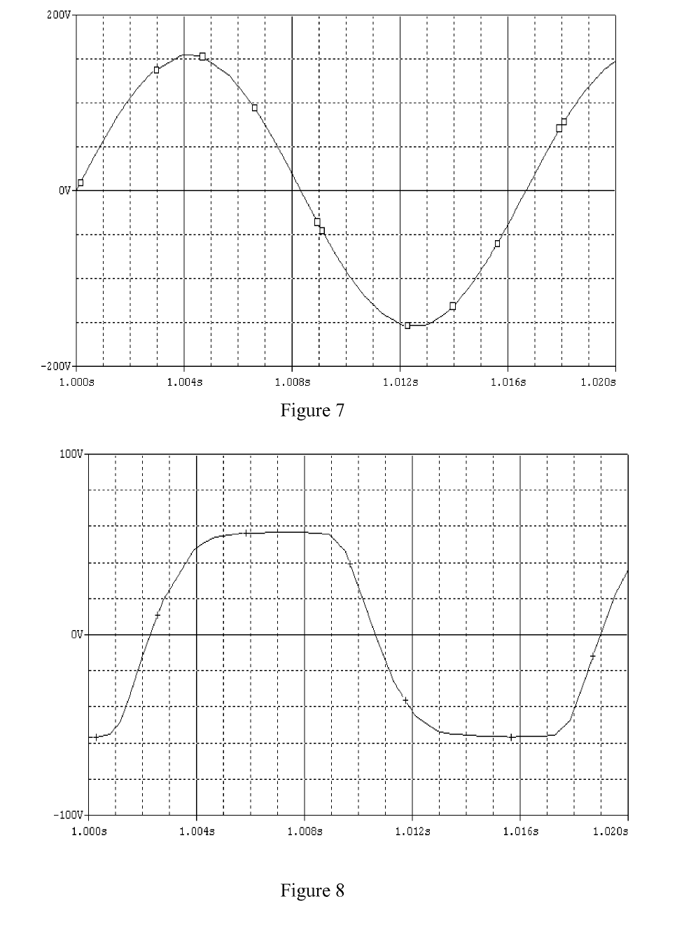

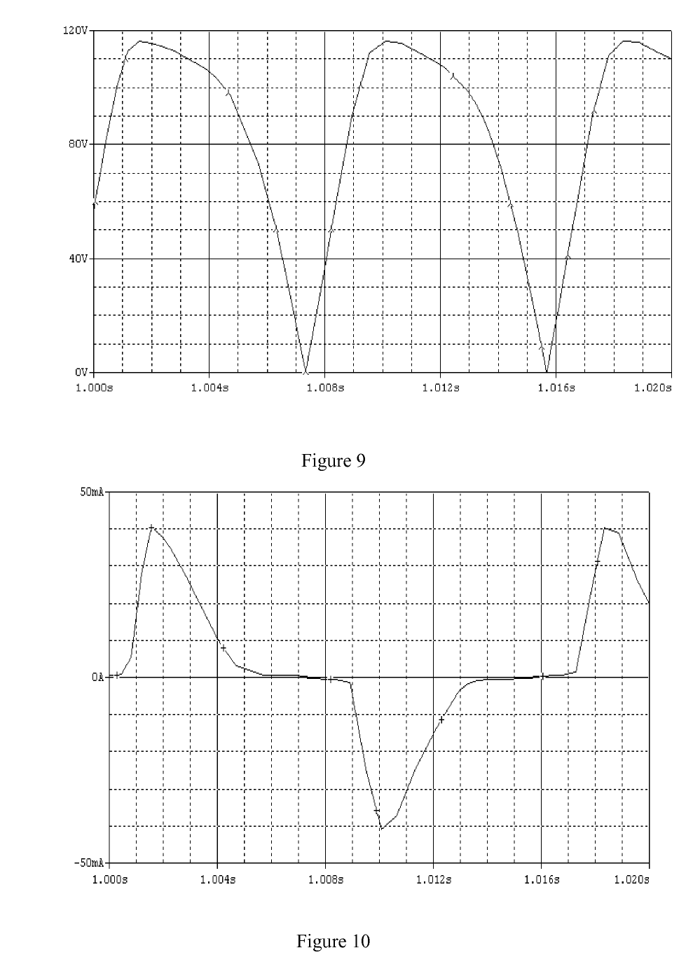

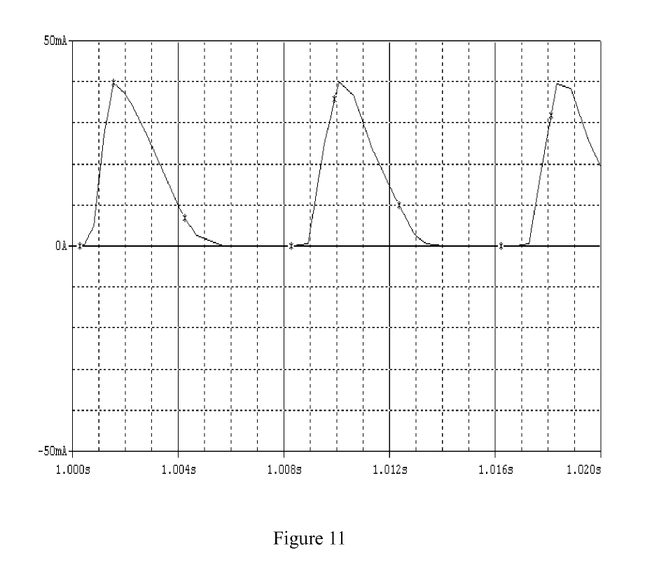

The transformer-free LED lighting device directly utilizing the AC power from city electricity in example 1 is used, wherein the AC is 110V, and there are thirty LED in series connecting between two output ends of the bridge rectifier circuit. The relationship among input voltage and time, the change of the voltage on both sides of the capacitor, the voltage on both sides of the LED, the current flowing through the capacitor and the current flowing through the LED with time are analyzed respectively, the results are shown in the FIGS. 7 to 11, the capacitance is adjusted to 0.82 u, and it may made the LED current to be 20 mA and the voltage of both sides of the LED to be 88V, the AC is flowing through the capacitor, the current is 20 mA, the DC is flowing through the LED, the current is 20 mA. When going through the rectifier bridge, the current is changed from AC to DC, and the frequency is doubled. The actual power consumption of the whole current is about 88V×20 mA=1760 mW, the actual power consumption of AC is 110V×20 mA=2200 mW, so the power factor is 1760/2200=80%.

From the above examples, it can be seen that the transformer-free LED lighting device directly utilizing the AC power from city electricity in this invention may directly use the AC power from city electricity without transformer, and the number of LED connected is more, the power factor is larger, such that better utilization rate of the AC power.

While the applications above have only shown the some utilizations of this invention, it is understood that various different applications can also be done base on the basic principle of this invention.

1. A transformer-free LED lighting device using the AC power from city electricity directly, which is characterized in that:
the transformer-free LED lighting device using the AC power from city electricity directly comprises a coupling capacitor, a bridge rectifier circuit and a current limiting resistor, wherein, there is a current limiting resistor cascading between the first input end of the bridge rectifier circuit and the first leading-in end of the electrical source of the AC power from city electricity, there is a coupling capacitor cascading between the second input end of the bridge rectifier circuit and the second leading-in end of the electrical source of the AC power from city electricity, there is a LED tube connecting between two output ends of the bridge rectifier circuit.

2. The transformer-free LED lighting device using the AC power from city electricity directly according to claim 1, which is characterized in that:
the coupling capacitor is used to limit the current used by the device and eliminate the need of the transformer.

3. The transformer-free LED lighting device using the AC power from city electricity directly according to claim 1, which is characterized in that:
the LED tube containing one or more LED chips in series, that connects the two output ends of the bridge rectifier circuit.

4. The transformer-free LED lighting device using the AC power from city electricity directly according to claim 1, which is characterized in that:
the current limiting resistor is used to protect the device in case of sudden changes of AC condition.

5. The transformer-free LED lighting device using the AC power from city electricity directly according to claim 1, which is characterized in that:
the bridge rectifier circuit is used to make LED tube emit light during every “charge and discharge” cycle of capacitor, so LED tube fulgurates twice every AC cycle to avoid the visible glitter.

6. The transformer-free LED lighting device using the AC power from city electricity directly according to claim 1, which is characterized in that:
the bridge rectifier circuit ensures that the same group of LED tubes provide the same brightness during the cycle of charge and discharge to eliminate twinkling effect for the lighting that happens when utilizing separate LED tubes for charge and discharge cycles.
